(19) United States
(12) Patent Application Publication
(10) Pub. No.: US 2019/0390625 A1
(43) Pub. Date: Dec. 26, 2019

(54) AIR AMOUNT CALCULATION DEVICE

(71) Applicant: DENSO CORPORATION, Kariya-city (JP)

(72) Inventors: Nobuhiro NITTA, Kariya-city (JP); Souichi SAITOU, Kariya-city (JP)

(21) Appl. No.: 16/559,942

(22) Filed: Sep. 4, 2019

Related U.S. Application Data
(63) Continuation of application No. PCT/JP2018/010540, filed on Mar. 16, 2018.

(30) Foreign Application Priority Data
Mar. 30, 2017 (JP) 2017-068128

(51) Int. Cl. F02D 41/18; G01F 1/00

(52) U.S. Cl. CPC F02D 41/18; G01F 1/00

(57) ABSTRACT

An air amount calculation device is configured to receive a detection signal from an air amount sensor provided in an intake air passage of an engine and to calculate an air amount of air flowing through the intake air passage based on the detection signal. The air amount calculation device includes: an acquisition unit configured to acquire an air amount calculation parameter using a detection point within an intermediate range intermediate between a maximum value and a minimum value in the detection signal; and an air amount calculation unit configured to calculate the air amount based on the air amount calculation parameter.

### CROSS REFERENCE TO RELATED APPLICATION

The present application is a continuation application of International Patent Application No. PCT/JP2018/010540 filed on Mar. 16, 2018, which designated the U.S. and claims the benefit of priority from Japanese Patent Application No. 2017-068128 filed on Mar. 30, 2017. The entire disclosures of all of the above applications are incorporated herein by reference.

### TECHNICAL FIELD

The present disclosure relates to an air amount calculation device configured to calculate an amount of air flowing through an intake air passage of an engine.

### BACKGROUND

Conventionally, an air amount sensor is located in an intake air passage of an engine to detect an amount of air (intake air flow rate) flowing through the intake air passage.

### SUMMARY

According to an aspect of the present disclosure, an air amount calculation device is configured to receive a detection signal from an air amount sensor provided in an intake air passage of an engine and to calculate an air amount of air flowing through the intake air passage based on a parameter calculated from the detection signal.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a schematic configuration of an engine control system;

FIG. 2 is a diagram showing a detection waveform of a detection signal,

FIG. 3 is a diagram illustrating functional blocks of an ECU;

FIG. 4 is a flowchart showing a calculation process;

FIG. 5 includes (a) and (b) which are diagrams showing a detection waveform and a detection point of a detection signal; and

FIG. 6 is a diagram showing the detection waveform of the detection signal.

### DETAILED DESCRIPTION

To begin with, investigations made for the present disclosure will be described. A conceivable configuration for an engine control is, for example, to detect an average air amount by using an air amount sensor or the like and to control an internal combustion engine based on the average air amount as detected. It is noted that, a detection signal of the air amount sensor could exhibit a waveform due to an influence of intake pulsation or the like. In consideration of the form of the detection signal, it is conceivable to employ a configuration to calculate a threshold based on an amplitude value and a mean value, which are calculated based on the peak value, and to cut a part of a crest or a trough achieving a peak value of a detection signal by the threshold calculated. In this way, the configuration may calculate an intake air flow rate based on the detection signal as being cut. This is an assumable option to improve a calculation accuracy of the intake air flow rate.

It is further noted that a waveform indicated by the detection signal may be generally disturbed by superimposition of harmonics in addition to a fundamental wave due to an influence of pulsation or the like. In particular, noise tends to be noticeable in the crest and the trough forming the peak value.

In the above-described conceivable configuration, the threshold value for the cutting the part is set based on the amplitude value and the mean value which are calculated based on the peak value. In other words, the threshold for cutting the part is likely set based on the amplitude value at which the error is likely to be large. As a result, the detection signal after cutting could be also susceptible to an error. Thus, in the case where the intake air flow rate is calculated based on the detection signal in which the cutting has been made with the threshold, it could be difficult to improve the calculation accuracy.

In view of the investigations, according to one example of the present disclosure, an air amount calculation device is configured to receive a detection signal from an air amount sensor provided in an intake air passage of an engine and to calculate an air amount of air flowing through the intake air passage based on the detection signal. The air amount calculation device includes: an acquisition unit configured to acquire an air amount calculation parameter using a detection point within an intermediate range intermediate between a maximum value and a minimum value in the detection signal; and an air amount calculation unit configured to calculate the air amount based on the air amount calculation parameter.

In the air amount sensor provided in the intake air passage of the engine, the detection signal is caused to amplify between the local maximum value and the local minimum value due to the intake pulsation. In addition, a signal of a harmonic wave is superimposed on a detection signal of the air amount sensor. Thus, a concern arises that the calculation accuracy could be lowered by a signal of the harmonic wave at the local maximum value or the local minimum value. In this regard, in the above example, the air amount calculation parameter is acquired with the use of a detection point within the intermediate range intermediate between the local maximum value and the local minimum value in the detection signal of the air amount sensor. In addition, the air amount is calculated based on the air amount calculation parameter. In this way, the air amount is calculated without using the local maximum value and the local minimum value on which the harmonic signal is likely to be superimposed. Thus, the configuration enables to reduce degradation in the calculation accuracy caused by the harmonic signal.

In this way, the air amount calculation device according to the one example is configured to accurately calculate the amount of air flowing through an intake air passage.

Embodiments will be described below taking an engine control system provided with an air amount calculation device as an example. In the following embodiments, parts that are the same or equivalent to each other are denoted by the same reference numerals in the drawings, and the description of the parts denoted by the same reference numerals is referred to.

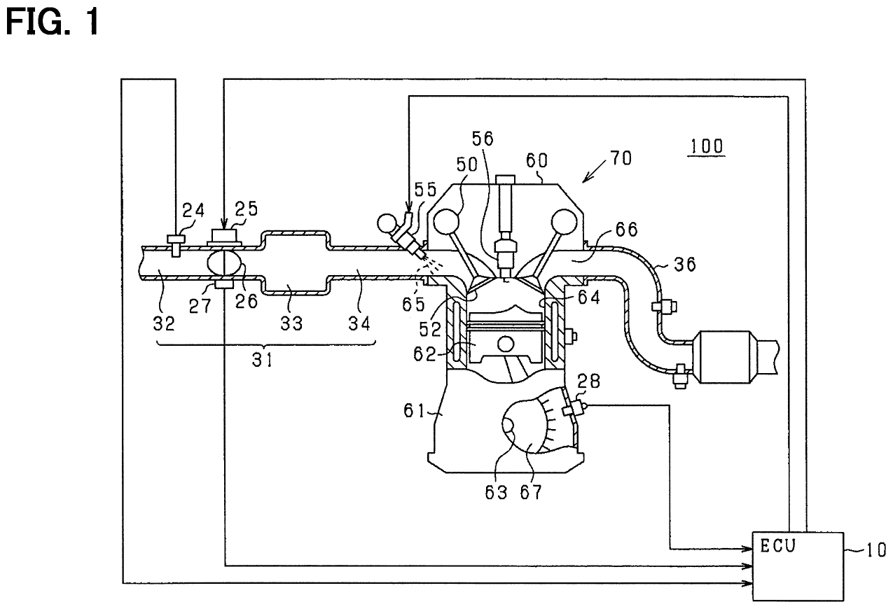

An engine control system 100 shown in FIG. 1 includes an engine 70, an intake air passage 31, an exhaust passage 36, and an ECU 10 as an air amount calculation device. The engine control system 100 controls an output of the engine 70 by changing an injection amount of fuel in accordance with the air amount (hereinafter referred to as intake air flow rate) flowing through the intake air passage 31. The engine control system 100 includes multiple sensor groups, and controls driving of the engine 70 based on an output from each sensor group.

The engine 70 includes a cylinder head 60, a cylinder block 61, a piston 62, and a crankshaft 63. The cylinder head 60 is located above the cylinder block 61, and an intake valve drive device 50 and an ignition plug 56 are located in the cylinder head 60. The cylinder block 61 includes multiple (3 in the present embodiment) cylinders 64, and an intake port 65 and an exhaust port 66 communicate with each of the cylinders 64. Hereinafter, in the engine 70, the intake air passage 31 side will be described as an upstream side, and the exhaust passage 36 side will be described as a downstream side. A fuel injection valve 55 is located in the intake port 65.

The intake valve drive device 50 is a device for switching the intake valve 52 between a valve open state and a valve close state, and switching the opening and closing between the intake port 65 and the intake air passage 31.

The fuel injection valve 55 is a device for injecting a fuel supplied from a fuel tank (not shown). The fuel injection valve 55 switches the opening and closing of the valve by, for example, a drive unit such as a solenoid or a piezoelectric element. In FIG. 1, the engine 70 is of a port injection type, and a tip side of the fuel injection valve 55 is located toward the intake port 65. When the engine 70 is of the in-cylinder injection type, the tip side of the fuel injection valve 55 from which the fuel is injected is located toward the cylinder 64.

The piston 62 is slidably located within a cylinder 64. The crankshaft 63 is rotatably connected to the piston 62 through a connection rod, and rotates in accordance with the sliding of the piston 62. A timing rotor 67 which rotates in accordance with the rotation of the crankshaft 63 is connected to the crankshaft 63. A detection gear is formed on an outer periphery of the timing rotor 67.

A crank angle sensor 28 for detecting a detection gear of the timing rotor 67 is attached to the outside of the cylinder block 61. The crank angle sensor 28 outputs a crank angle signal NE indicating the rotation angle of the crankshaft 63 in response to detection of the detection gear of the timing rotor 67. A crank angle signal NE is used to detect the crank angle [° CA] of the engine 70 and a rotation speed [rpm] of the engine 70.

The intake air passage 31 is a passage through which air mainly taken in from the outside flows, and includes an upstream side passage 32, a surge tank 33, and an intake manifold 34. The upstream side passage 32 communicates with the outside through an air cleaner (not shown) on the upstream side, and communicates with a surge tank 33 on the downstream side end. The surge tank 33 communicates with an intake manifold 34 corresponding to the number of cylinders on the downstream side. The downstream side of the intake manifold 34 communicates with the cylinder 64 through the intake port 65.

The upstream side passage 32 is provided with an air flow meter 24 as an air amount sensor. The air flow meter 24 detects an intake air flow rate as a physical quantity, and outputs a detection signal of an output voltage corresponding to the intake air flow rate. As the air flow meter 24, for example, a hot wire type can be used, but a flap type or a Kalman vortex type may be used.

A throttle valve 26 whose opening is adjusted by a motor 25 and a throttle opening sensor 27 which detects the opening degree (throttle opening degree) of the throttle valve 26 are provided on the downstream side of the air flow meter 24.

The exhaust passage 36 is a flow channel through which an exhaust gas discharged from the cylinder 64 flows. The exhaust passage 36 has one end connected to the exhaust port 66 and the other end connected to an exhaust manifold (not shown).

The ECU 10 is an electronic control unit that mainly includes a microcomputer such as a CPU, and performs various controls of the engine control system 100 based on signals detected by using various sensors with the use of control programs stored in a built-in ROM. In the present embodiment, the ECU 10 sets the fuel injection amount and controls an ignition timing of the ignition plug 56. In setting the fuel injection amount, the ECU 10 calculates the fuel injection amount according to the operation states of the engine 70 based on the detection signals from an air flow meter 24.

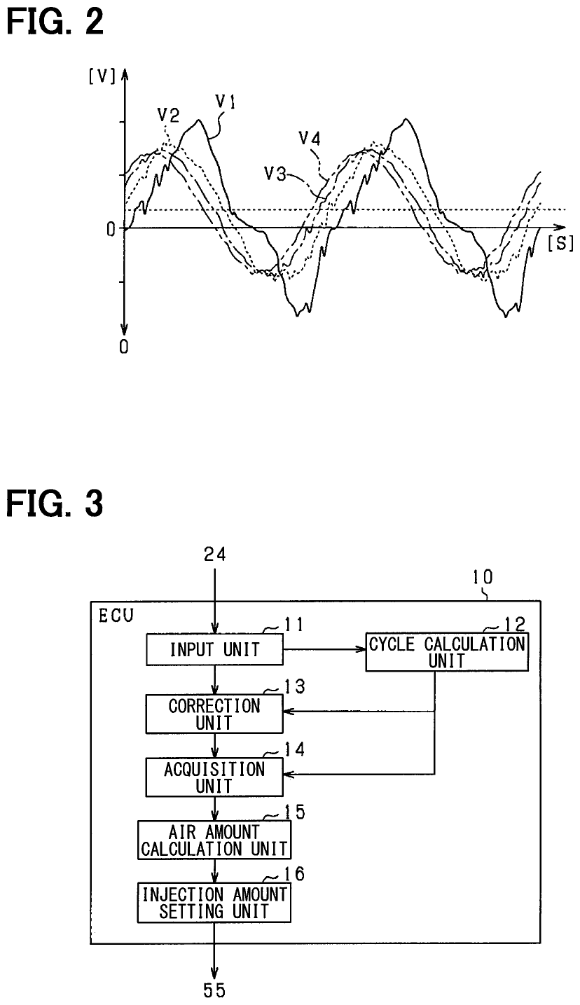

Next, the detection waveform indicated by the detection signal of the air flow meter 24 will be described with reference to FIG. 2. A waveform V1 in FIG. 2 is a detection waveform indicated by a detection signal of the air flow meter 24.

In an intake stroke of the engine 70, the intake valve 52 is opened, and the position of the piston 62 changes from a top dead center (TDC) to a bottom dead center (BDC). For that reason, the air in the intake air passage 31 is taken into the cylinder 64 through the intake port 65 (intake air flow rate increases). On the other hand, in a compression stroke, the intake valve 52 is put into a valve close state in principle, so that the intake air flow rate decreases. For that reason, an intake pulsation occurs in the intake air passage 31. The intake pulsation causes the detection signal to exhibit a detection waveform having a constant cycle.

The intake pulsations occur periodically in accordance with the opening and closing of the intake valve 52 and the sliding of each piston 62, but the intake pulsations generated by the sliding of each piston 62 are combined together in time series on the upstream side of the intake air passage 31 (the upstream side passage 32 and the surge tank 33). As a result, as shown in FIG. 2, the detection waveform indicated by the detection signal of the air flow meter 24 indicates a waveform having a constant cycle in which a harmonic is superimposed on the fundamental wave.

Therefore, in the vicinity of the peak value (local maximum value and local minimum value), the detection waveform is liable to be distorted (susceptible to noise) by the influence of harmonic. On the other hand, if a median amplitude (average flow rate) of the detection signals within an intermediate range intermediate between the local maximum value and the local minimum value can be grasped, the intake air flow rate can be calculated. Therefore, with the use of the detection signal (detection point) within the intermediate range intermediate between the local maximum value and the local minimum value in the detection waveform, the air amount calculation parameter is acquired, the intake air flow rate (the amount of air flowing into the intake air passage 31) is calculated based on the air amount calculation parameter, and the calculation accuracy of the intake air flow rate is improved. A detailed description will be given below.

First, the functional blocks of the ECU 10 will be described with reference to FIG. 3. The ECU 10 functionally includes an input unit 11, a cycle calculation unit 12, a correction unit 13, an acquisition unit 14, an air amount calculation unit 15, and an injection amount setting unit 16. The functional blocks shown in FIG. 3 are realized by causing the CPU of the ECU 10 to execute programs stored in the ROM.

The input unit 11 inputs a detection signal of the air flow meter 24 every predetermined cycle (for example, every several μsec). The cycle calculation unit 12 calculates a frequency (fundamental frequency) and a fundamental cycle of the fundamental wave included in the detection waveform indicated by the detection signal based on the rotation speed of the engine 70 and the number of cylinders (the number of cylinders 64, three cylinders in the present embodiment) connected to the intake air passage 31.

The correction unit 13 performs correction for reducing the influence of harmonic other than the fundamental wave from the detection signal of the air flow meter 24 with the use of the fundamental cycle or the like. The acquisition unit 14 obtains an air amount calculation parameter with the use of a detection point within the intermediate range intermediate between the local maximum value and the local minimum value in the detection signal. At that time, the detection point within the intermediate range is appropriately identified by leveraging the fundamental cycle or the like. The air amount calculation unit 15 calculates the intake air flow rate based on the air amount calculation parameter.

The injection amount setting unit 16 acquires the fuel injection amount based on the intake air flow rate calculated by the air amount calculation unit 15. The fuel injection amount is information for setting the amount of fuel injected by the fuel injection valve 55, and is output to the fuel injection valve 55.

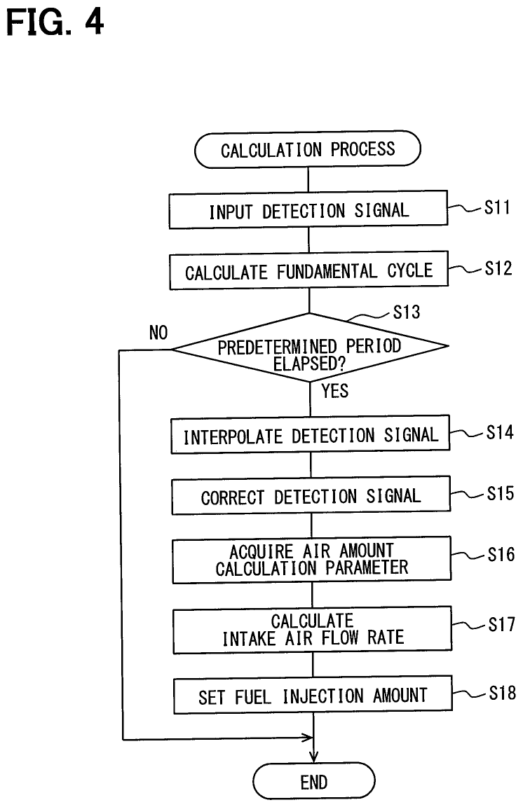

Next, a calculation process in which the ECU 10 calculates the intake air flow rate based on the signal detected by using the air flow meter 24 will be described with reference to a flowchart of FIG. 4. The calculation process shown in the flowchart of FIG. 4 is, for example, a process repeatedly performed at a predetermined cycle (for example, at predetermined time intervals). The predetermined period is, for example, a period sufficiently shorter than the pulsation cycle (fundamental cycle), and may be set based on the rotation speed of the engine 70 and the number of cylinders 64.

In Step S11, the ECU 10 inputs a signal detected by using the air flow meter 24. The ECU 10 includes a filter circuit, and receives the detection signal from the air flow meter 24 through the filter circuit. Specifically, the filter circuit is an RC filter that attenuates an amplitude of a predetermined cutoff frequency. The cutoff frequency to be attenuated may be set in accordance with, for example, a frequency band in which the detection signal is used or a frequency calculated based on the sampling theorem. The use frequency band of the detection signal is calculated based on an upper limit of the rotation speed of the engine 70, the number of cylinders connected to the intake air passage 31 (the number of cylinders 64, hereinafter the same is applied), and a harmonic order allowed to be superimposed. A bandpass filter may be used.

In addition, the input detection signal is stored in a storage unit such as a RAM provided in the ECU 10. At this time, it is desirable to store a detection signal in a period corresponding to at least one period of a fundamental cycle T.

In Step S12, the ECU 10 calculates the fundamental frequency and the fundamental cycle according to the intake stroke based on the present rotation speed of the engine 70 and the number of cylinders. For example, the fundamental cycle T[s] is calculated by applying the current rotation speed R[rpm] of the engine 70 and the number of cylinders S to the following Expression (1). The fundamental frequency H [Hz] is calculated according to a reciprocal of the fundamental cycle T. The calculated fundamental cycle T and fundamental frequency H are stored in a storage unit such as a RAM included in the ECU 10.

[Expression 1]

T=(60/R)/(S/2) (1)

In Step S13, the ECU 10 determines whether or not a predetermined period has elapsed since the previous calculation of the intake air flow rate. Since a process of calculating the intake air flow rate is the process after Step S15, it is determined whether or not a predetermined period of time has elapsed since the determination of Step S14 has been affirmed last time. The predetermined period in the present embodiment is a period from a start to an end of the intake stroke, but may be arbitrarily changed. For example, the predetermined period may be a period from the start of the intake stroke to the end of the compression stroke, or a period obtained by multiplying the period of the fundamental cycle T or half of the fundamental cycle T by an integer. The predetermined period may be determined based on the opening and closing timing of the intake valve 52 or the sliding timing of the piston 62. When a predetermined period of time has elapsed since the previous calculation of the intake air flow rate, the process proceeds to Step S15, and when the predetermined period has not elapsed, the process is completed.

In Step S14, the ECU 10 performs interpolation of the stored detection signals according to, for example, linear interpolation.

In Step S15, the ECU 10 performs a connection for reducing the effects of harmonic other than the fundamental wave from the detection signal. As described above, the detection waveform represented by the detection signal represents a waveform (cyclic wave) having a constant cycle in which the fundamental wave and its harmonic are superimposed on each other. Therefore, when the concept of Fourier transform is applied, the detection waveform is a sum of a fundamental wave which is a repetition frequency and a harmonic wave having a frequency which is an integral multiple of the fundamental wave. In other words, the detection waveform can be decomposed into a fundamental wave, which is a repetition frequency, and a harmonic wave having a frequency which is an integral multiple of the fundamental wave. A multiple of the fundamental wave is denoted as a harmonic order (rotation order). An area of the detection waveform (cyclic wave) (product of the detected air amount and time) coincides with a product of the value of the steady component of the detection waveform and time. In other words, the value of the steady component coincides with an average flow rate.

On the other hand, when a sine wave having a certain cycle and the sine wave shifted by a phase (τ) are added together, the following Expression (2) is established by combination of a trigonometric function. In Expression (2), t is time, T is a fundamental cycle, n is an order, and τ is a shift time.

$$[ Expression 2 ]$$

$$sin ( \frac{n 2 π t}{T} ) + sin ( \frac{n 2 π ( t + τ )}{T} ) = \sqrt{2} \{ 1 + cos ( \frac{n 2 πτ}{T} ) \} \cdot sin ( \frac{n 2 π t}{T} + Δ ) \qquad ( 2 )$$

In particular, when the phase is shifted by a time (τ=T/2n), Expression (2) becomes 0. This indicates that if the phase (τ) is shifted by a time (T/2n), the sine wave is cancelled.

Therefore, the ECU 10 performs a correct for canceling an influence of a predetermined harmonic (output component of the harmonic) from the detection signal by adding a detection signal to the detection signal whose phase is shifted together. The phase (τ), by which the detection signal is to be shifted, is calculated on the basis of the fundamental cycle T and the order n of a predetermined harmonic to be reduced.

In the present embodiment, when the harmonic whose order is “2” is to be reduced, the detection signal and the detection signal whose phase (τ) is shifted by a time (T/4) are added together, and the added value is divided by 2, to thereby perform the correction. Since there is a need to recognize a value of the steady component, the value is divided by 2. In other words, division by 2 is performed because the value of the steady component is doubled.

When the harmonic whose order is “3” is to be reduced, the detection signal and the detection signal whose phase (τ) is shifted by time (T/6) are added together, and the added value is divided by 2, to thereby perform the correction. The harmonic of another order is reduced in the same manner. Those corrections are repeated for each harmonic order to be reduced. In the present embodiment, the correction for reducing the harmonics of predetermined orders (2, 3, 4) from the detection signal is performed.

FIG. 2 shows a detection waveform after correction. In FIG. 2, a waveform V2 (dashed line) is a detection waveform of a detection signal in which the harmonic whose order is “2” is reduced, a waveform V3 (one dot chain line) is a detection waveform of a detection signal in which the harmonics whose orders are “2, 3” are reduced, and a waveform V4 (two dot chain line) is a detection waveform of a detection signal in which harmonics whose orders are “2, 3, 4” are reduced.

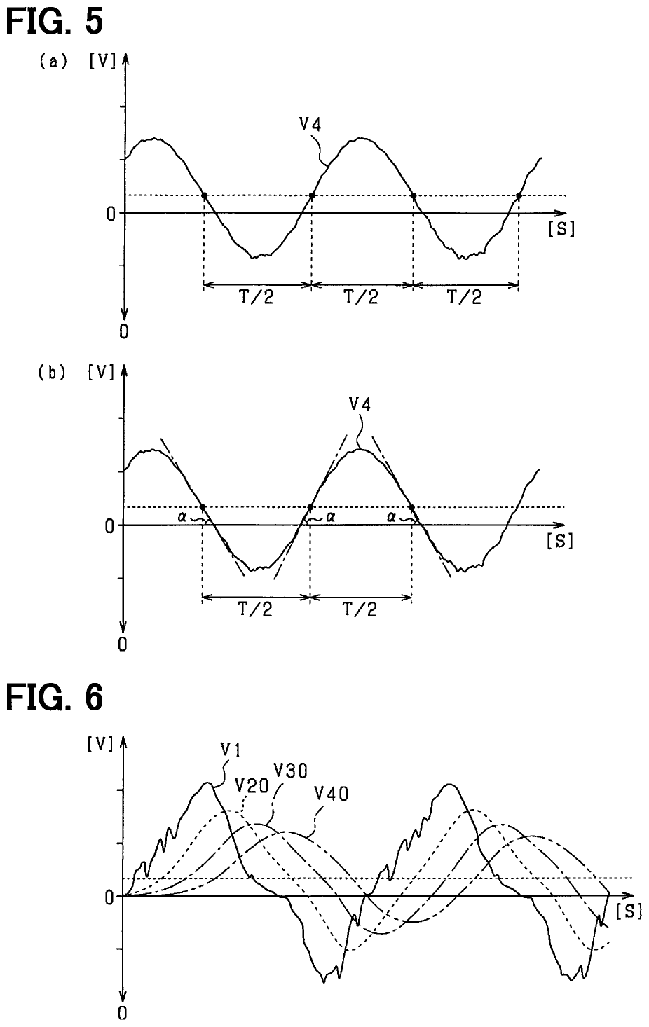

In Step S16, the ECU 10 acquires an air amount calculation parameter with the use of detection points within an intermediate range intermediate between the local maximum value and the local minimum value in the corrected detection signal. More specifically, the ECU 10 sets a timing at which the detection signal crosses over a predetermined value within the intermediate range as a detection point, and acquires a predetermined value and a time interval between the adjacent detection points as the air amount calculation parameter. As shown in FIG. 5, the predetermined value in the present embodiment is the median amplitude at which the detection signal crosses over the predetermined value at the time interval (T/2) which is half the pulsation cycle (fundamental cycle T) of the detection signal. The median amplitude corresponds to a value of the steady component, that is, an average flow rate.

A process in Step S16 will be described in more detail. In the corrected detection signal, the ECU 10 sets a determination value within an intermediate range of the detection signal. The intermediate range is a value corresponding to 10% to 90% of a value (voltage value) of the input detection signal in the amplitude direction. The ECU 10 sets the timing at which the detection waveform crosses over the determination value as the detection point. In the present embodiment, since the median amplitude is set to a predetermined value, as shown by (a) in FIG. 5, when the time interval between the detection points coincides (or substantially coincides) with the time interval (T/2) which is half of the pulsation cycle (fundamental cycle T) of the detection signal, it is determined that the detection signal crosses over the predetermined value. In other words, when the time interval between the detection points obtained by changing the determination value within the intermediate range coincides with the time interval of half of the fundamental cycle T, it is determined that the detection signal crosses over the predetermined value.

The processing in Step S16 may be performed by a method other than the method described above. For example, in Step S16, the ECU 10 first sorts (identifies) combinations of two detection signals in which the time interval between the two detection signals (detection points) is the time interval (T/2) which is half the fundamental cycle T. The ECU 10 may determine that the detection signal crosses over the predetermined value when a difference (voltage difference) of the combined detection signals among the identified combinations becomes 0 (or a value in the vicinity of 0). In other words, when a detection signal (detection point) of the same output voltage is input at a time interval (T/2) of half of the fundamental cycle T, it may be determined that the detection signal crosses over the predetermined value. In this case, a time point at which the detection signal of the same output voltage is input is a time point at which it is determined that the detection signal crosses over the predetermined value.

Further, for example, the ECU 10 may identify the time point at which the detection signal (detection point) of the same output voltage is input, and may determine that the detection signal crosses over the predetermined value when the difference between the time interval between the two identified (no difference) detection signals and the time interval (T/2) of half of the fundamental cycle T becomes 0 (or a value in the vicinity of 0).

For example, the ECU 10 sets two detection signals (detection points) input for each predetermined period (calculation process cycle) as one set. Then, for all the combinations (combinations of two detection signals), the ECU 10 identifies a difference (voltage difference) between the detection signals and a time interval (input time interval) between the combined detection signals for each combination. When there is a combination in which the time interval coincides (or substantially coincides) with the time interval which is half of the fundamental cycle T and the difference between the detection signals is 0 (or a value in the vicinity of 0) among all the combinations, the ECU 10 may determine that the detection signal crosses over the predetermined value.

The fundamental cycle T can be accurately calculated based on the rotational speed and the number of cylinders of the engine 70. For that reason, when the determination is made based on the fundamental cycle T, the detection signal is hardly susceptible to the error. When the detection signal (detection point) of the same output voltage is input at the time interval which is half of the fundamental cycle T, the detection signal is the median amplitude. The median amplitude is a value expected to have a high detection accuracy compared to the peak value because the harmonic is less likely to be superimposed on the median amplitude. For that reason, the calculation accuracy of the intake air flow rate can be improved.

In addition, for example, the ECU 10 may set a timing at which the inclination of the detection waveform indicated by the detection signal becomes a predetermined inclination as a detection point in the intermediate range, and acquire the time interval between the adjacent detection points as the air amount calculation parameter. More specifically, the ECU 10 may set a timing at which the inclination α of the detection waveform indicated by the detection signal becomes maximum (or an inclination in the vicinity of the maximum) within the intermediate range as the detection point, and acquire the value of the detection signal at the timing and the time interval between the adjacent detection points as the air amount calculation parameter. In addition, as shown by (b) in FIG. 5, the ECU 10 may determine that the detection signal crosses over the predetermined value when the timing at which the inclination of the detection waveform indicated by the detection signal reaches the maximum (or the inclination in the vicinity of the maximum) is set as the detection point, and the time interval between the adjacent detection points coincides (or substantially coincides) with the time interval of which is half of the fundamental cycle T.

When the determination is made on the basis of the slope (the amount of change per unit time, that is, a value equal to or greater than two), the detection signal is less susceptible to the error as compared with the case of determining whether or not the value has reached the predetermined value. In addition, detection points other than the vicinity of the peak value can be appropriately determined by the inclination.

In either case, the fundamental cycle T and the value of the detection signal input at the time point when it is determined that the detection signal crosses over the predetermined value (that is, the air amount corresponding to an output voltage or an output voltage) are acquired as the air amount calculation parameter. If there are multiple time points (detection points) at which it is determined that the detection signal crosses over the predetermined value within a predetermined period (a predetermined period in Step S14), the value of the detection signal may be the latest value among the detection signals, or may be a value obtained by averaging multiple values. Instead of the fundamental cycle T, a predetermined period or a time interval which is half of the fundamental cycle T may be acquired as the air amount calculation parameter.

The ECU 10 may set the median amplitude based on the time interval between the detection point at the time of an upward change (a period during the upward change) of the detection signal and the detection point at the time of a downward change (a period during the downward change) at the intermediate value within the intermediate range, and make the determination based on whether or not the detection signal crosses over the median amplitude. At this time, when the time interval between the detection point at the time of the upward change of the detection signal at the intermediate value within the intermediate range and the detection point at the time of the downward change coincides (or substantially coincides) with the time interval (T/2) which is half of the fundamental cycle T, the ECU 10 sets the value of the detection signal at the detection point as the median amplitude. The ECU 10 may acquire the fundamental cycle T and the median amplitude as the air amount calculation parameters.

In Step S17, the ECU 10 calculates the intake air flow rate based on the acquired air amount calculation parameter. Specifically, the ECU 10 calculates the intake air flow rate in the fundamental cycle T by multiplying the fundamental cycle T acquired as the air amount calculation parameter by the air amount identified in accordance with the value of the detection signal. In other words, the value of the detection signal repeated every time interval (T/2) which is half of the fundamental cycle T is the median amplitude, and the average flow rate can be identified. For that reason, the intake air flow rate in the fundamental cycle T can be calculated by multiplying the fundamental cycle T by the air amount identified in accordance with the value of the detection signal. Although the intake air flow rate in the fundamental cycle T is calculated in the present embodiment, the intake air flow rate in a predetermined period (a predetermined period in Step S14) or a timer interval which is half of the fundamental cycle T may be calculated.

In Step S18, the ECU 10 sets the fuel injection amount based on the calculated intake air flow rate. For example, the ECU 10 sets the fuel injection amount based on the intake air flow rate calculated in Step S18 and the throttle opening degree from the throttle opening sensor 27. Thereafter, the ECU 10 controls the fuel injection valve 55 based on the set fuel injection amount to inject the fuel into the cylinder 64 of the engine 70.

The configuration described above provides the following effects.

In the air flow meter 24 provided in the intake air passage 31 of the engine 70, the detection signal is amplified between the local maximum value and the local minimum value due to the intake pulsation. In addition, a harmonic signal is superimposed on the detection signal of the air flow meter 24, resulting in a concern that the detection accuracy may be lowered due to the influence of the harmonic in the local maximum value and the local minimum value. In this regard, in the configuration described above, the air amount calculation parameter is acquired with the use of the detection point within the intermediate range intermediate between the maximum value and the minimum value in the detection signal of the air flow meter 24, and the intake air flow rate (air amount) is calculated based on the air amount calculation parameter. In that case, since the intake air flow rate is calculated without using the local maximum value or the local minimum value on which the harmonic signal is likely to be superimposed, the deterioration of the detection accuracy caused by the influence of the harmonic can be reduced.

Since the operation state of the engine 70 changes each time, the intake air flow rate flowing through the intake air passage 31 also changes each time. In that case, although the median amplitude of the detection signal changes, the median amplitude of the detection signal can be appropriately set by setting the median amplitude based on the time interval between the detection point at the time of the upward change and the detection point at the time of the downward change of the detection signal.

Since the air amount calculation parameter is acquired based on the detection signal after the correction for reducing the harmonic has been performed, the calculation accuracy of the intake air flow rate can be improved.

The ECU 10 performs the correction for reducing a predetermined harmonic from the detection signal by adding the detection signal and the detection signal whose phase is shifted together. Since only a predetermined harmonic can be cancelled and reduced, the calculation accuracy of the intake air flow rate can be improved. In other words, in the case of using a low-pass filter, all the signal components of the cutoff frequency are attenuated, but only a predetermined harmonic can be canceled in the configuration described above. In addition, when the low-pass filter is used, the output component of the cutoff frequency can be attenuated but cannot be eliminated. However, when the detection signal whose phase has been shifted is added together, the influence of the predetermined harmonic can be eliminated.

The ECU 10 uses the detection signal input through a filter circuit for attenuating components of the predetermined frequency. As a result, noise can be attenuated, and the calculation accuracy of the intake air flow rate can be improved.

In Step S16, when the intake air flow rate is calculated, a value in the vicinity of the peak value (extreme value) in the amplitude direction of the input detection signals is cut (omitted). Since the detection signal (detection point) within the intermediate range is used, the calculation accuracy is not affected even if the above value is cut. In addition, unnecessary calculation is reduced.

### Other Embodiments

The present disclosure is not limited to the embodiments described above, and may be implemented as follows, for example. In the following description, parts identical or equivalent to each other in the respective embodiments are denoted by the same reference numerals, and the description of the parts denoted by the same reference numerals will be referred to.
In Step S16, when the intake air flow rate is calculated, the value in the vicinity of the peak value (extreme value) in the amplitude direction of the input detection signals is cut (omitted), but the value may not be cut. For example, all the values in the amplitude direction of the input detection signals may be set as the determination value.
In Step S11, the detection signal is input through the filter circuit, but the filter circuit may be omitted.
In Step S14, the detection signal is interpolated, but may not be interpolated.
In Step S14, when the detection signal is interpolated, only a part of the detection signal may be interpolated, for example, only an intermediate range may be interpolated.
The correction in Step S15 may not be performed.
In Step S15, the ECU 10 may perform the correction for reducing the harmonic included in the detection signal with the use of a filter (for example, a digital low-pass filter) in which an attenuation frequency to be attenuated is set in accordance with the fundamental cycle T of the fundamental wave. In that case, the attenuation frequency may be set based on the harmonic frequency calculated based on the fundamental frequency. In this case, when the harmonics of multiple orders are attenuated, low-pass filters whose attenuation frequencies are set for each order may be superimposed on each other. As a result, with the use of the low-pass filters, all the frequencies after the attenuation frequency are attenuated, and as shown in FIG. 6, the amplitude is reduced every time the filter is missing. However, since the value within the intermediate range is maintained, the intake air flow rate can be calculated. In FIG. 6, a waveform V20 (dashed line) is a detection waveform of a detection signal in which the harmonic whose order is “2” is reduced, a waveform V30 (one dot chain line) is a detection waveform of a detection signal in which the harmonics whose orders are “2, 3” are reduced, and a waveform V40 (two dot chain line) is a detection waveform of a detection signal in which harmonics whose orders are “2, 3, 4” are reduced.
The ECU 10 includes all of the input unit 11, the cycle calculation unit 12, the correction unit 13, the acquisition unit 14, the air amount calculation unit 15, and the injection amount setting unit 16, but the functions may be shared by multiple control devices. For example, the air flow meter 24 may be provided with a control device, and the control device may be provided with some or all of the functions of the ECU 10.
When the fundamental cycle and the fundamental frequency are calculated, the fundamental cycle and the fundamental frequency may be identified by assuming the periodicity of the input detection signal. In other words, an interval at which the same value is repeated with the same inclination may be set as the fundamental cycle. In particular, the above setting is effective when the engine rotation speed and the number of cylinders are unknown.
An execution timing of the process of calculating the fundamental frequency and the fundamental cycle in Step S12 may be arbitrarily changed. For example, the calculation process may be executed when the determination result in Step S13 is affirmative, and the calculation may be performed at a timing other than the timing at which the calculating process is performed.
When setting the cutoff frequency of the filter circuit used in Step S11, the cutoff frequency may be set based on the minimum value of the cutoff frequency calculated based on the sampling theorem and the use frequency band of the detection signal.
Although the fundamental cycle and the fundamental frequency are calculated based on the rotation speed of the engine 70, the fundamental cycle and the fundamental frequency may be calculated based on the crank angle signal NE and the rotation speed of the engine 70.
The predetermined cycle in which the calculation process is executed may be executed every time the crank angle advances by a predetermined angle. In that case, the detection signal is input at every predetermined crank angle.
When the cutoff frequency of the filter circuit used in Step S11 is set based on the sampling theorem, and when the detection signal is input (sampled) at a predetermined time interval, the cutoff frequency may be set based on the predetermined time interval. On the other hand, when the detection signal is input (sampled) at intervals of a predetermined angle (crank angle), the cutoff frequency may be set based on the predetermined angle interval. It is preferable that the predetermined angle interval is calculated as the slowest sampling interval based on a lower limit of the rotation speed of the engine 70 and the crank angle per revolution of the engine 70, and the cutoff frequency is calculated at the sampling interval.
In Step S16 of FIG. 4, the predetermined value is set as the median amplitude, but the predetermined value may be changed to any value as long as the value falls within the intermediate range. At that time, the timing at which the detection signal crosses over the predetermined value within the intermediate range is set as the detection point, and the intake air flow rate is calculated based on the time interval between the adjacent detection points. For example, the median amplitude may be estimated based on the predetermined value and a ratio of the time intervals between the adjacent detection points, and the intake air flow rate may be calculated.
The ECU 10 may set the median amplitude used in the current air amount calculation with reference to the amplitude median value used in the previous air amount calculation. For example, in Step S16 of FIG. 4, the ECU 10 may identify the detection point with the median amplitude used in the previous air amount calculation as the predetermined value, and set the median amplitude used in the current air amount calculation based on the time interval between the adjacent detection points. More specifically, the ECU 10 may adjust the median amplitude based on the ratio of the time intervals between the adjacent detection points. With the above adjustment, when the median amplitude is calculated, candidate values can be narrowed down, and a calculation load can be reduced. The previously calculated median amplitude may be used as is, under a steady state where the rotation speed of the engine 70 is stable.

Although the present disclosure has been described in accordance with the examples, it is understood that the present disclosure is not limited to such examples or structures. The present disclosure encompasses various modifications and variations within the scope of equivalents. In addition, various combinations and forms, as well as other combinations and forms that include only one element, more, or less, fall within the scope and spirit of the present disclosure.

1. An air amount calculation device configured to receive a detection signal from an air amount sensor provided in an intake air passage of an engine and to calculate an air amount of air flowing through the intake air passage based on the detection signal, the air amount calculation device comprising:
an acquisition unit configured to acquire an air amount calculation parameter using a detection point within an intermediate range intermediate between a maximum value and a minimum value in the detection signal; and
an air amount calculation unit configured to calculate the air amount based on the air amount calculation parameter.

2. The air amount calculation device according to claim 1, wherein
the acquisition unit is configured
to set, as the detection point, a timing at which the detection signal crosses over a predetermined value within the intermediate range, and
to acquire, as the air amount calculation parameter, a time interval between adjacent detection points including the detection point, and
the air amount calculation unit is configured to calculate the air amount based on the predetermined value and the time interval between the adjacent detection points.

3. The air amount calculation device according to claim 2, wherein
the predetermined value within the intermediate range is a median amplitude at which the detection signal crosses over the predetermined value at a time interval of half of a pulsation cycle of the detection signal, and
the acquisition unit is configured
to set, as the detection point, a timing at which the detection signal crosses over the median amplitude and
to acquire, as the air amount calculation parameter, the time interval between the adjacent detection points.

4. The air amount calculation device according to claim 3, further comprising:
a setting unit configured to set the median amplitude based on a time interval between a detection point of an upward change and a detection point of a downward change of the detection signal at an intermediate value within the intermediate range.

5. The air amount calculation device according to claim 4, wherein
the setting unit is configured to set the median amplitude used in a current air amount calculation with reference to the median amplitude used in a previous air amount calculation.

6. The air amount calculation device according to claim 1, wherein
the acquisition unit is configured
to set, as the detection point, a timing at which a slope of the detection signal becomes a predetermined slope within the intermediate range and
to set, as the air amount calculation parameter, a time interval between adjacent detection points including the detection point, and
the air amount calculation unit is configured to calculate the air amount based on a value of the detection signal at the detection point and the time interval between adjacent detection points.

7. The air amount calculation device according to claim 6, wherein
the acquisition unit is configured
to set, as the detection point, a timing at which the slope of the detection signal becomes maximum within the intermediate range, and
to acquire, as the air amount calculation parameter, the time interval between the adjacent detection points.

8. The air amount calculation device according to claim 1, further comprising:
a cycle calculation unit configured to calculate a fundamental cycle of the detection signal based on a rotation speed of the engine and a number of cylinders connected to the intake air passage; and
a correction unit configured to perform correction for reducing harmonic other than a fundamental wave from the detection signal based on the fundamental cycle calculated by the cycle calculation unit.

9. The air amount calculation device according to claim 8, wherein
the correction unit is configured to add a signal, in which the detection signal is shifted in phase, to the detection signal to perform correction for reducing harmonic from the detection signal, and
the correction unit is configured to calculate the signal, in which the detection signal is shifted in phase, based on the fundamental cycle and a harmonic order to be reduced.

10. The air amount calculation device according to claim 8, wherein
the correction unit is configured to perform correction for reducing the harmonic included in the detection signal by using a filter having an attenuation frequency to be attenuated set in accordance with a fundamental cycle of the fundamental wave.

11. The air amount calculation device according to claim 1, further comprising:
a filter circuit configured to attenuate a component of a predetermined frequency of the detection signal.

12. An air amount calculation device configured to be coupled of an air amount sensor provided in an intake air passage of an engine, the air amount calculation device comprising:
a memory;
a processor coupled to the memory and configured to:
receive a detection signal from the air amount sensor;
set a first timing at which the detection signal crosses over a predetermined value within an intermediate range, wherein the intermediate range is intermediate between a maximum value and a minimum value in the detection signal and which excludes the maximum value and the minimum value;
set a second timing at which the detection signal crosses over the predetermined value, wherein the second timing is adjacent to the first timing; and
calculate an air amount of air flowing through the intake air passage based on the predetermined value and a time interval between the first timing and the second timing.

13. An air amount calculation device configured to be coupled of an air amount sensor provided in an intake air passage of an engine, the air amount calculation device comprising:
a memory;
a processor coupled to the memory and configured to:
receive a detection signal from the air amount sensor;
set a first timing at which a slope of the detection signal within an intermediate range becomes a predetermined slope, wherein the intermediate range is intermediate between a maximum value and a minimum value in the detection signal and which excludes the maximum value and the minimum value;
set a second timing at which the slope of the detection signal within the intermediate range becomes the predetermined slope, wherein the second timing is adjacent to the first timing; and
calculate an air amount of air flowing through the intake air passage based on the detection signal at the first timing or the second timing and a time interval between the first timing and the second timing.
